(19) United States
(12) Patent Application Publication
(10) Pub. No.: US 2010/0250384 A1
(43) Pub. Date: Sep. 30, 2010

(54) Method and system for electronically ordering goods or services

(76) Inventor: Ashish Bhargava, San Jose, CA (US)

Correspondence Address: Ashish Bhargava, 7176 McKean Ct, San Jose, CA, 95120, US

(21) Appl. No.: 12/413,549

(22) Filed: Mar. 28, 2009

(51) Int. Cl. G06Q 30/00; G01C 21/36

(52) U.S. Cl. 705/26; 701/209

(57) ABSTRACT

Methods and systems for electronically ordering goods or services by an individual and obtaining the same by pick-up or delivery using a time and distance-optimizing system are provided. Based on individual's origin and destination, and also based on either an additional distance/additional time chosen by individual, the system displays providers in the area on and around a least time route or least distance route, so that it will satisfy either the parameter of the least time+the additional time or the parameter of the least distance+the additional distance. The individual places order, pays therefor and obtains the goods/ service by reaching the provider by using the best route as communicated by the system from origin to provider and thereafter to destination.

### FIELD OF THE INVENTION

The present invention relates to a method and system for electronically ordering goods or services by an individual. Such system of the invention in various embodiments functions as a time and distance-optimizing system. The system and method of the invention can be applicable for ordering goods, for instance groceries, gifts, flowers and the like. Similarly services in which the invention can be used include among the many, restaurants for food take-out and delivery, salon visits, laundry drop-off and pick-up, car wash, choosing gas station, doctors, dentists, car mechanics etc.

### BACKGROUND OF THE INVENTION

There are well known systems/websites in the art which enable browsing a selection of service providers like restaurants or grocers, browse through their menus or inventory list and place an order for goods or service online or by telecommunication. The order is communicated by the website via Fax or Online to the service provider. Further most of these are for delivery services only although some of these providers allow for a take-out option as well. Till date there is no system or method known, by which an individual can electronically order goods or service from a provider, based on a chosen time frame or a chosen distance. Similarly there is also no system or method known till date, wherein an individual seeks for a goods or service provider enroute from a location to a destination and further seeks to obtain his goods/service within a chosen time frame or distance. There is a need for a method and system which allows choosing a time or distance based provider and ordering his goods/service so as to minimize traveling and/or obtaining the goods in optimal or earliest time or distance.

### BRIEF DESCRIPTION OF THE DRAWINGS

Accordingly an object of the invention is to provide a method and a system for electronically ordering goods or services within a chosen time or from within a chosen distance by an individual, using a time and distance-optimizing system. In one embodiment of the invention, the goods/service is obtained by pick-up or take-out from a chosen goods or service provider. In another embodiment of the invention, the goods/service is obtained by delivery at a chosen location by a chosen provider. In yet another embodiment of the invention, the goods/service is picked-up enroute from a location to a destination from a chosen provider within a chosen time frame or chosen distance that the individual is willing to spend in obtaining his order or service. The foregoing and other objects and advantages of the invention are better understood from the following detailed description of a preferred embodiment of the invention with reference to the drawings, in which:

FIG. 1 depicts, in a simplified and representative form, a system for ordering goods or services in accordance with one aspect of the present invention.

FIG. 2 is a flow chart depicting the method of ordering goods or service according to one aspect of the invention

FIG. 3 is a flow chart depicting the method of ordering goods or service according to another aspect of the invention.

FIG. 4 is a flow chart depicting the method of ordering goods or service according to another aspect of the invention.

FIG. 5 is a flow chart depicting the method of ordering goods or service according to another aspect of the invention.

### DETAILED DESCRIPTION OF THE INVENTION

According to one aspect of the invention, there is provided a method of electronically ordering goods or services by an individual using a time and distance-optimizing system, which comprises:
(a) providing the individual with a device or interface equipped with a time and distance-optimizing system, into which the individual provides origin and destination information, following which the system displays route options including one of least time and one of least distance between the origin and destination;
(b) the individual further providing to the system, a request for goods or service and either an additional time or additional distance over the least time or least distance that the individual is willing to spend in obtaining the goods or service at a goods or service provider and reaching the destination;
(c) the individual making a selection of the provider from the list of providers displayed by the system which is compiled as those being in the geographical area on and around the least time route or the least distance route, based on either the additional distance or additional time chosen by the individual, so that it will satisfy either the parameter of the least time+the additional time or the parameter of the least distance+the additional distance;
(d) the individual placing the order and paying therefor; and
(e) the individual then obtaining the goods or service by reaching the provider from the origin using the best route as communicated by the system and thereafter reaching the destination as communicated by the system; in a manner that will satisfy either the parameter of the least time+the additional time or the parameter of the least distance+the additional distance

The term “provider” wherever used hereinafter refers to a goods/service provider.

Accordingly there is provided a time and distance-optimizing system as per the invention for use by an individual for electronically ordering goods or services, which:
(a) allows the individual provided with a device or interface equipped with the system, to provide his origin and destination information therein, following which the system displays route options including one of least time and one of least distance between the origin and destination;
(b) allows the individual to further provide to the system, a request for goods or service and either an additional time or additional distance over the least time or least distance that the individual is willing to spend in obtaining the goods or service at a goods or service provider said reaching the destination;
(c) computes and displays the geographical area on and around the least time route or the least distance route, based on either the additional distance or additional time chosen by the individual, so that it will satisfy either the parameter of the least time+the additional time or the parameter of the least distance+the additional distance, and then provides a list of providers in the said area and then allows the individual to make a selection of the provider from the list;
(d) allows the individual to place the order and pay therefor; and
(e) communicates to the individual the best route of reaching his provider from origin to obtain goods or service and thereafter communicates to the individual the best route to reach the destination, in a manner that will satisfy either the parameter of the least time+the additional time or the parameter of the least distance+the additional distance.

In one aspect of the invention, the provider is a restaurant and the method facilitates food take-out, origin to destination enroute.

According to another embodiment of the invention, after step (d), the system allows the individual to further select additional goods or service provider(s) based on the time or distance remaining from the parameter of the least time+the additional time or the parameter of the least distance+the additional distance.

According to a second aspect of the invention there is provided a method of electronically ordering and seeking delivery of goods or services by an individual, which comprises:
(a) providing the individual with a device or interface equipped with a system into which the individual provides a location information and a goods or service request, following which the system displays various providers in the geographical areas marked within concentric circles from the location, and also displays the delivery time of the goods or service at the location, in each concentric circle;
(b) the individual making a selection of the provider from a concentric circle based on a desired delivery time, placing the order, paying therefor and receiving an order confirmation from the system; and
(c) the individual obtaining the goods or service by delivery at the location within the desired delivery time.

Accordingly there is provided a system, as per the invention, for use by an individual for electronically ordering goods or services, which:
(a) allows an individual provided with a device or interface equipped with the system, to provide a location information and a goods or service request therein, following which the system displays various providers in the geographical areas marked within concentric circles from the location, and also displays a delivery time of the goods or service at the location, in each concentric circle;
(b) allows the individual to make a selection of the provider from a concentric circle based on a desired delivery time; and
(c) allows the individual to place the order, pay therefor, receive an order confirmation and thereafter obtain the goods or service by delivery at the location within the desired delivery time.

In one aspect of the invention, the provider is a restaurant and the method facilitates a food delivery.

According to one embodiment of the invention, the innermost circle within the concentric shows the least time or least distance and the outermost circle of the concentric shows the longest time or longest distance.

According to another embodiment of the invention, the system further allows the individual to select a provider after narrowing down from the list of providers in step (a) based on the nature of goods or service he seeks.

According to a third aspect of the invention, there is provided a method of electronically ordering and picking-up goods or services by an individual using a time and distance-optimizing system, which comprises:
(a) providing the individual with a device or interface equipped with a time and distance-optimizing system, into which the individual provides a location information, a request for goods or service and either a desired time or desired distance that the individual is willing to spend in obtaining the goods or service at a goods or service provider; following which the system displays various providers around the location who will satisfy the parameter of either the desired time or the desired distance in obtaining the goods or service;
(b) the individual making a selection of the provider and paying for the order;
(c) the individual obtaining die goods or service by reaching the provider from the location using the best route as communicated by the system in a manner that will satisfy either the parameter of the desired time or the parameter of the desired distance.

Accordingly there is provided a time and distance-optimizing system as per the invention, for an individual for electronically ordering and picking-up goods or services, which
(a) allows the individual provided with a device or interface equipped with the system, to provide therein a location information, a request for goods or service and either a desired time or desired distance that the individual is willing to spend in obtaining the goods or service at a goods or service provider; following which the system displays various providers around the location who will satisfy the parameter of either the desired time or the desired distance in obtaining the goods or service;
(b) allows the individual to make a selection of the provider and pay for the order;
(c) communicates to the individual the best route to reach the provider from the location in a manner that will satisfy either the parameter of the desired time or the parameter of the desired distance; and obtain the goods or service.

In one aspect of the invention, the provider is a restaurant and the method facilitates a food pick-tip/take-out.

In one aspect of the invention, the innermost circle within the concentric shows the least time or least distance and the outermost circle of the concentric shows the longest time or longest distance.

According to one embodiment of the invention, after step (b), the system allows the individual to further select additional goods or service provider(s) based on the time or distance remaining from the parameter of the desired time or the parameter of the desired distance.

According to another embodiment of the invention, the system allows the individual to select a provider after narrowing down from the list of providers in step (a) based on the nature of goods or service he seeks.

According to yet another embodiment of the invention, tie desired time or desired distance includes obtaining goods or service and reaching the location back using the best route communicated by the system.

According to a fourth aspect of the invention, there is provided a method of electronically ordering and picking-up goods or services by an individual, which comprises:
(a) providing the individual with a device or interface equipped with a system into which the individual provides a location information and a goods or service request, following which the system displays various goods or service providers in the geographical areas marked within concentric circles from the location with either the time or distance information within each concentric circle that will be consumed in obtaining the goods or service;
(b) the individual making a selection of the provider from a concentric circle based on a desired time or a desired distance;
(c) the individual placing the order, paying therefor and receiving an order confirmation from the system; and
(d) the individual obtaining the goods or service by reaching the goods or service provider from the location using the best route as communicated by the system in a manner that will satisfy either the parameter of the desired time or the parameter of the desired distance.

Accordingly there is provided as per the invention, a system for an individual for electronically ordering and picking-up goods or services, which:
(a) allows the individual provided with a device or interface equipped with a system, to provide a location information and a goods or service request therein, following which the system displays various providers in the geographical areas marked within concentric circles from the location with either the time or distance information within each concentric circle that will be consumed in obtaining the goods or service;
(b) allows the individual to make a selection of the goods or service provider from a concentric circle based on a desired time or a desired distance;
(c) allows the individual to place the order, paying therefor and receive an order confirmation from the system; and
(d) communicates to the individual the best route to reach the provider from the location and obtain the goods or service, in a manner that will satisfy either the parameter of the desired time or the parameter of the desired distance.

According to one aspect of the invention, the provider is a restaurant and the method facilitates food take-out.

According to an embodiment of the invention, the system allows the individual to select a provider after narrowing down from the list of providers in step (a) based on the nature of goods or service he seeks.

According to yet another embodiment of the invention, the desired time or desired distance includes obtaining goods or service and reaching the location back using the best route communicated by the system.

All the above aspects of the inventions may find utility in ordering groceries, gifts, flowers and the like. Similarly services in which the invention can be used include among the many, restaurants for food take-out and delivery, salon visits, laundry drop-off and pick-up, car wash, choosing gas station, doctors, dentists, car mechanics etc. A preferred aspect of the invention is when the service provider is a restaurant.

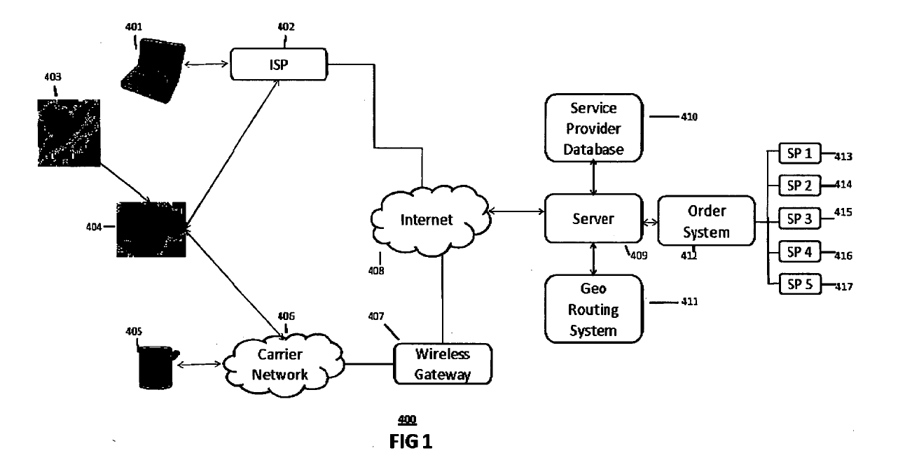

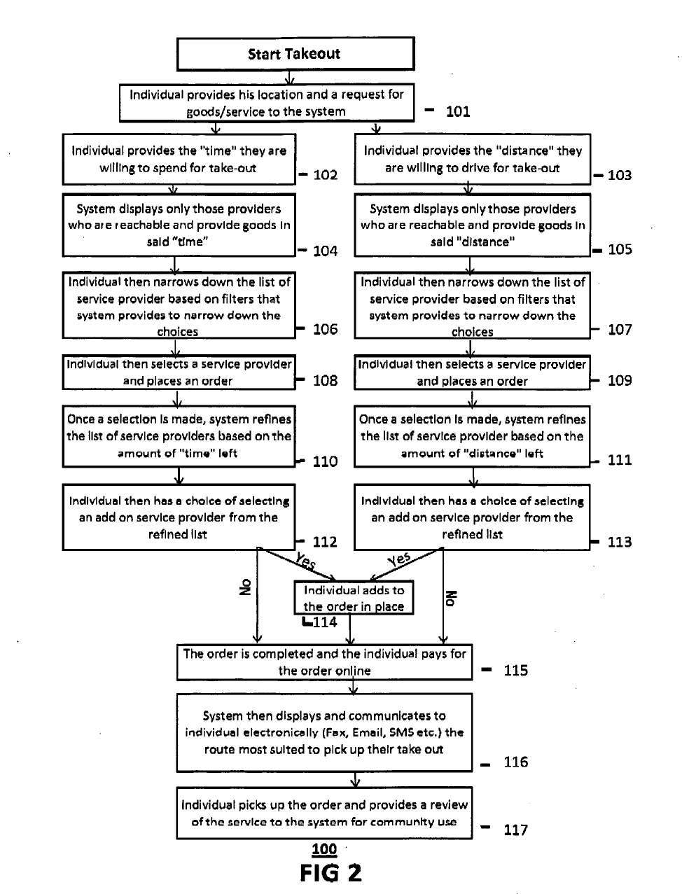

Referring to FIG. 1 of the accompanying drawings, the system therein illustrates how the individual user interfaces with the system according to an embodiment of the invention. The individual may use a single or multiple devices to interact with the system. Multiple devices include a laptop (401), web enabled Smartphone/PDA (405) and Internet enabled Global Positioning system i.e. OPS (404). In the present embodiment, the laptop (401) is connected to a server (409) over the internet through an Internet Service Provider i.e. ISP (402). 404 is a GPS device which connects to the internet via a cell phone network through an ISP in a manner similar to that of device 401. 403 is a satellite which helps the GPS to determine its location. The Smartphone/PDA (405) connects over a carrier network (406) via a wireless network through Wireless Access Protocol (WAP) gateway (407) to the internet (408) and the server (409). The server (409) finds the appropriate goods or service provider that meets the individual's interaction criteria as discussed herein below with reference to FIGS. 2-5.

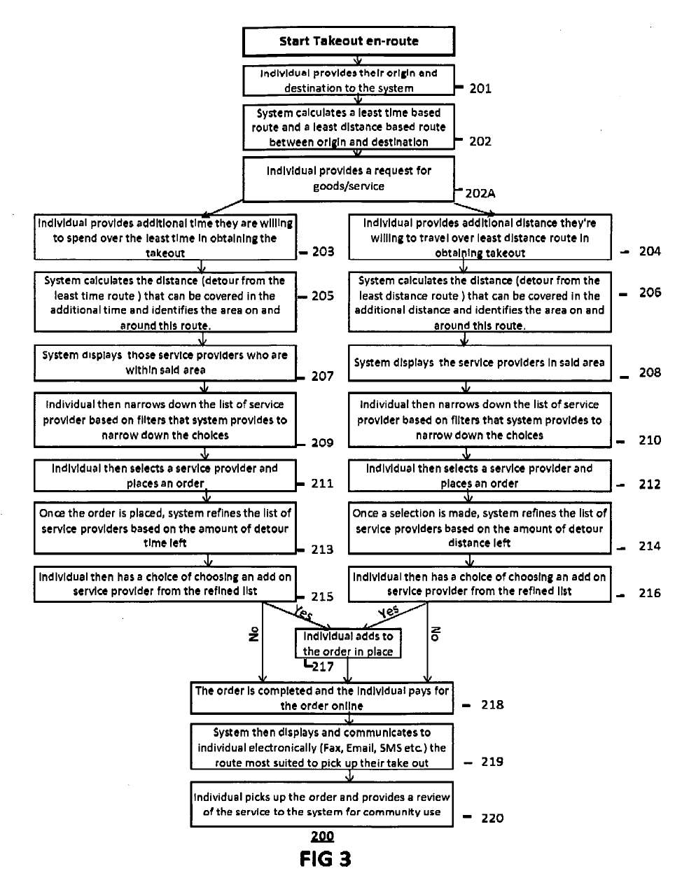

FIG. 3 of the accompanying drawings describes an embodiment of the invention wherein the individual wants to do a take-out of goods/service, for example, food, enroute from the individual's location, for example work place, to a destination, for example, home (201) from a goods/service provider, for example, a restaurant. The system used by the individual is programmed in a manner so as to help the individual seek a particular provider within a desired time flame or within a desired distance. The individual provides to the system the location viz. work place and destination viz. home addresses. When the device is a OPS or GPS enabled device, it is understood to a person skilled in the art that the individual's location is automatically communicated to the system by the OPS or GPS enabled device. With the location and destination information, the system calculates the least distance based route (in miles, say, 12 miles) and a least time based route (in minutes or hours), for example, 43 minutes (202), using the mapping application programming interface (API) provided by open source community like Maptools.org or from companies like Google, Yahoo, Microsoft, MapQuest etc. The least time and least distance for routes are calculated using criteria like traffic, highways, highway speed limits etc. The system then allows the individual to make a specific request for goods or service, for example, food/restaurant by browsing through the database of service provider categories maintained in system database (202A). Then it further allows the individual to make a choice of whether he would like to spend an additional time from the least time in obtaining food (203). This feature of the system is enabled using technology to create these dynamic web pages via PHP (Personal Home Page), database technology like MySQL and programming languages like JAVA. When the individual chooses the additional time, say for example 15 minutes, over the least time (43 minutes), the system then proceeds to calculate the area on and around the least time route that can be covered by the individual driving at legal speed and on road within the additional time the individual is willing spend in order to obtain food (205). The system uses programming languages like PHP, Java, .Net etc to calculate this information and provide this feature. The system then looks up restaurants within its database that have an address that falls within the said area and will provide the food within the least time+additional time parameter of 58 minutes i.e. 43 minutes+15 minutes. The system then displays only those restaurants that satisfy the 58 minutes time criteria (207). Since the server (409) has extensive information about service providers like restaurants (413, 414, 415, 416, and 417) and information on offered services like type of food, etc it helps the individual to select the restaurant he is interested in. The individual is then allowed by the system to filter down the results (209) based on a variety of criteria like food menu, cost of food, quality of food based on the ratings die system maintained in its database (410) The system then allows the individual to place an order within the system using web interface developed using PHP, Java etc. (211). Once the order is placed, the system calculates the amount of time left, for example, 10 minutes, from the parameter of least time+additional time i.e. 58 minutes, after inclusion of the stop at the selected restaurant. It then recalculates the area that the individual can cover in that leftover time between the said restaurant stop and the destination. Once that area is calculated, it again proceeds to look up service providers like restaurants that fall in that area and displays this additional selection to the individual (213). The system allows the individual, at this stage, to make a decision of either choosing a 2^{nd} restaurant or not (215). This feature provided by the system is enabled by PHP, Java and My SQL programming, if the individual chooses a 2^{nd} restaurant, he goes through to place an order (217) in the same manner as explained above. Once the order(s) is placed, the individual pays for the order through electronic payment method (218) using credit card, bank debit, gift cards. Many optional features may be provided by the system. Like for instance, the system can also provide an option for the individual to pay the goods or service provider in cash on delivery; following which the system confirms the order placement (219) via one of the many options like Short Message Service (SMS), email or fax. The system similarly communicates the order to the service provider (219). As in the above example, when the service provider is a restaurant, once the goods or service provider receives the order, they then proceed to prepare the food, and thereafter make the food available for take-out at the desired time, which is within the parameter of least time+additional time (220). The system may also provide a provision for the individual to rate the particular dish (in case of restaurant), service or goods after they have received the delivery of the goods or service. The review is optional for the individual to enable him narrow the choice of goods/service providers. This feature adds to the usefulness and effectiveness of the system.

As per another aspect of the invention, referring once again to FIG. 3, the above application of the system can be utilized by an individual, when it allows the individual to choose an additional distance over and above the least distance, for example 8 miles, in obtaining his goods/service, for example, food (204). In the same manner as explained hereinabove, when the individual chooses the additional distance he is willing to travel over the least distance (12+8 miles), the system then proceeds to calculate the area on and around the route that can be covered by the individual driving at legal speed within the additional distance specified in obtaining the food (206). The system then looks Lip restaurants within its database (410) that have an address that falls within the said area and will enable food take-out within the distance of 20 miles and displays only those restaurants (208). The individual is then allowed by the system to filter down the results as explained above, following which the system displays only the restaurants that meet the individual's exacting standards (209). The individual then selects a particular restaurant (412), sorts through the menu and places all order within the system (212) Once the order is placed, the system calculates the amount of distance left from the parameter of least distance+additional distance after inclusion of the selected restaurant stop. It then recalculates the area that the individual can cover in that leftover time between the restaurant r stop and the destination. Once that area is calculated, it again proceeds to look up service providers, for example, restaurant that fall in that area and displays these additional selections to the individual (214). The system allows the individual, at this stage, to make a decision of either choosing a 2^{nd} restaurant or not (216), if he chooses a 2^{nd} restaurant, he goes through to place an order (217), and further obtains the food in the same manner as explained above.

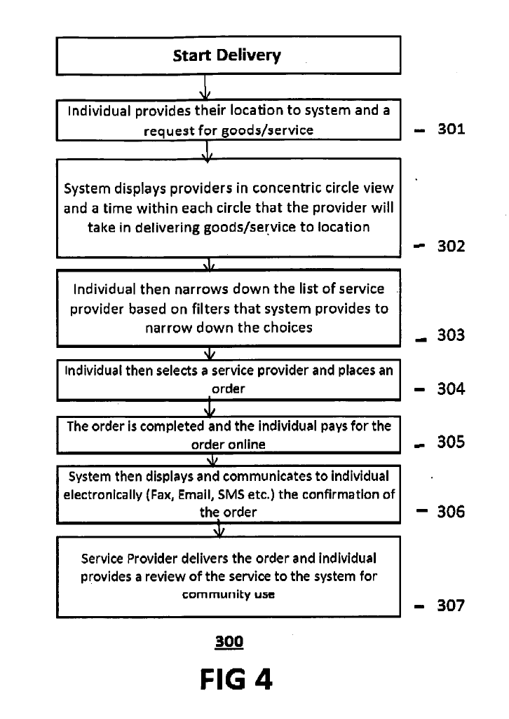

Referring to FIG. 4 of the accompanying drawings, this system (300) enables an individual to obtain delivery of goods/service at a desired location viz. home, within a desired time frame. In this case, the only information the individual provides to the system is the location (301). As explained above, this step may be bypassed when the individual is interfacing with a GPS or GPS enabled devices. Based on location information, the system's route optimizing system searches through the database for service providers who can provide the goods or the service within different time frames; like for instance, firstly it looks up service providers around the location that can deliver service/goods to the location within a first time frame, for example, 30 minutes. Then the system calculates a second zone of providers that can deliver goods/service to the location within a second time frame greater than the first, for example 60 minutes. Then the system further calculates a third zone of service providers who can deliver to the location within a third time frame greater than the second time frame, for example, 90 minutes. The system then displays the results of its database query i.e. goods/service providers in concentric circles around the location and further map the delivery time viz. 30 minutes, 60 minutes and 90 minutes within each circle respectively (302). Tis feature of the system is enabled using PHP, Java, MySQL programming and the like. The results thus provided clearly indicate to the individual a wide array of choice of goods/service providers. As explained above in the earlier embodiment, the individual then proceeds to filter down the service/goods provider (303) and selects a particular service provider (304) sorts through the services and goods that meet their criteria and places an order within the system. The individual pays for the order through electronic payment method (305). The system may also provide for the individual to pay in cash upon delivery of goods/service. The system confirms the order placement (306) via one of the many options like Short Message Service (SMS), email or fax and similarly communicates the order to the goods/service provider. Where the service provider is a restaurant, upon receiving the order, the goods/service provider prepares the food and delivers the order within the desired time. The system also provides a provision for the individual to rate the particular dish (in case of restaurant), service or goods after they have received the delivery of the goods or service. This feature is similarly enabled by technologies like PHP, Java, .Net, MySQL etc. programming.

FIG. 2 (100) refers to a method/system wherein the individual wants to do a take-out of goods or service from a provider around the individual's location within a desired time or a desired distance. In this instance, the individual provides to the system the location information (101). As explained above, this step may be bypassed when the individual is interfacing with a GPS or GPS enabled devices. The system, using technologies like PHP, Java, .Net, MySQL etc. programming, then allows the individual to either provide a desired time or a desired distance the individual is willing to spend in obtaining the goods/service. If the individual chooses the time parameter (102), the system then calculates the area from around the individual's location that can be covered by the user driving at the legal speed limit, in obtaining his goods/service and reaching his location back The system looks up within its database, the service providers that have an address that falls within the said area around the location (104). This feature of the system is enabled using technologies like PHP, Java, .Net, MySQL etc programming. The system then allows the individual to filter clown the list of providers in the same maimer as explained above (106); following which only the service providers that meet the individual's exacting standards are displayed. The individual then selects a particular goods or service provider (108), sorts through the services and goods that meet their criteria and proceeds to place an order within the system. Once the order is placed, the system further calculates the amount of time left from the desired time provided by the individual (110). The system then recalculates the area that the individual can cover in that leftover time between the first service provider stop and the location. Then the system looks up service providers that fall in that area and displays it to the individual (112). At that stage, the individual makes a decision of whether to stop at a 2^{nd} service provider or not. If the individual chooses to add more goods and services, they place an order in a manner as explained above.

Once again while referring to FIG. 2 of the accompanying drawings, after providing the location information, if the individual chooses a desired distance instead of a desired time (103), the system then calculates the area from the individual's location that can be covered within the desired distance in miles. As explained above, the system looks up within its database the service providers that have an address that falls within the area around tie location (105). The system further allows the individual to select a goods or service provider after filtering (109) in the same manner as explained above. The system allows the individual to sort through the services and goods that meet his criteria and to place an order within the system. Once the order is placed, the system further calculates the number of miles left from the desired distance criteria provided by the individual. The system then recalculates the area that the individual can cover in that leftover distance between the first service/goods provider stop and the location (111). Once that area is calculated, it then proceeds to look up service/goods providers that fall in that area and displays it to the individual (113). At that stage, the individual makes a decision of whether to choose a 2^{nd} service/goods provider or not. And if he chooses to add more goods and services, the system provides to place an order. Once the order is placed, the system allows the individual to pay for the order through electronic payment method (115). The system can also provide an option for the individual to make payment upon take-out of goods/service. The system then proceeds to confirm the order placement (116) via one of the many options like Short Message Service (SMS), email or fax and similarly communicates the order to the goods/service provider. Where the service provider is a restaurant, upon receiving the order, they prepare the food and keep it ready for take-out within the desired time. The system also provides a provision for the individual to rate the particular dish (in case of restaurant), service or goods after they have picked up the goods or service.

In one embodiment of the above aspect of the invention, the desired time or desired distance includes take-out of the goods/service from a provider. In another embodiment of the invention, the desired time or desired distance includes take-out of the goods/service from a provider and reaching the location back.

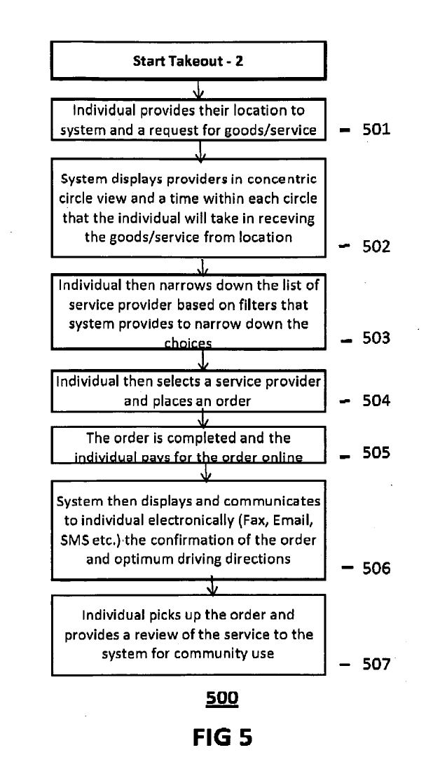

Referring to FIG. 5 of the accompanying drawings, this system (500) enables an individual to pick-up/tale-out goods or services from a provider by traveling from his location, for example home, to the provider within a desired time frame. In this case, the only information the individual provides to the system is the location (501). As explained above, this step may be bypassed when the individual is interfacing with a OPS or OPS enabled devices. Based on location information, the system's route optimizing system searches through the database for service providers who can provide the goods or the service within different time frames; like for instance, firstly it looks up service providers around the location that can be reached from the location to pick-up goods or services within a first time frame, for example, 30 minutes. Then the system calculates a second zone of providers that can be reached from the location to pick-up goods or services within a second time frame greater than the first, for example 60 minutes. Then the system further calculates a third zone of service providers that can be reached from the location within a third time frame greater than the second time frame, for example, 90 minutes. The system then displays the results of its database query i.e. goods/service providers in concentric circles around the location and further map the pick-up time viz. 30 minutes, 60 minutes and 90 minutes within each circle respectively (502). This feature of the system is enabled by PHP, Java, MySQL programming. The results thus provided clearly indicate to the individual a wide array of choice of goods/service providers. As explained above in the earlier embodiment, the individual then proceeds to filter down the service/goods provider (503) and selects a particular service provider (504), sorts through the services and goods that meet their criteria and places an order within the system. The individual pays for the order through electronic payment method (505). The system may also provide for the individual to pay in cash upon pick-up of goods/service. The system confirms the order placement (506) via one of the many options like Short Message Service (SMS), email or fax and similarly communicates the order to the goods/service provider. Where the service provider is a restaurant, upon receiving the order, the goods/service provider prepares the food and keeps it ready for pick-up within the desired time. The system also provides a provision for the individual to rate the particular dish (in case of restaurant), service or goods after they have received the goods or service. This feature is similarly enabled by technologies like PHP, lava, .Net, MySQL etc. programming.

In another aspect of the invention, the device is a GPS or has GPS capability built-in that may be used in any of the systems according to the invention.

Desired time/distance chosen by the individual may or may not be an optimal time and distance and may be based on various factors like traffic information etc. Similarly best route communicated by the system after placing an order with a goods/service provider is also based on factors like traffic information etc.

The invention provides for a very efficient time and/or distance optimizing methods/systems, easy to use and also user friendly. It provides for a very specific type of search for goods/service provider(s), viz. those that are within a desired time or desired distance and can be used in a take-out situation or one that can be used for delivery.

The above example of using technologies like PHP, Java, Net etc programming in the working of the system is only exemplary of the invention. There are other well-known ways in the art of designing a similar system such as FLEX, Flash, Oracle, ColdFusion, Java Server Pages (JSP), JavaScript, VBScript, etc. Further, devices 401, 404 and 405 of FIG. 1 are merely examples of devices that enable to understand the interface with the system, but the invention is certainly not limited to these and may utilize online interactive communication network like web interface, telephone etc. In the embodiments where the system displays various providers in concentric circles, it is understood that the number of circles forming the concentric is not limited to three as exemplified above. Further while various embodiments have been described above, it should be understood that they have been presented by way of an example only and not a limitation. Thus, the breadth and scope of a preferred embodiment should not be limited by any of the above described exemplary embodiments, but should be defined only in accordance with the following claims and their equivalents.

1. A method of electronically ordering goods or services by an individual using a time and distance-optimizing system, which comprises:
a. providing the individual with a device or interface equipped with a time and distance-optimizing system, into which the individual provides origin and destination information, following which the system displays route options including one of least time and one of least distance between the origin and destination;
b. the individual further providing to the system, a request for goods or service and either an additional time or additional distance over the least time or least distance that the individual is willing to spend in obtaining the goods or service at a goods or service provider and reaching the destination;
c. the individual making a selection of the provider from the list of providers displayed by the system which is compiled as those being in the geographical area on and around the desired route based on either the additional distance or additional time chosen by the individual, so that it will satisfy either the parameter of the least time+the additional time or the parameter of the least distance+the additional distance;
d. the individual placing the order and paying there for; and
e. the individual then obtaining the goods or service by reaching the provider from the origin using the best route as communicated by the system and thereafter reaching the destination as communicated by the system; in a manner that will satisfy either the parameter of the least time+the additional time or the parameter of the least distance+the additional distance.

2. A method as claimed in claim 1 in which, after step (d), the individual further selects additional goods or service provider(s) based on the time or distance remaining from the parameter of the least time+the additional time or the parameter of the least distance+the additional distance.

3. A method as claimed in claim 1, wherein the provider is a restaurant and the method facilitates a food take-out, origin to destination enroute.

4. A method as claimed in claim 1, wherein the individual selects a provider after narrowing down from the list of providers in step (c) based on the nature of goods or service he seeks.

5. A method as claimed in claim 1, wherein the device has a Global Positioning System (GPS) capability built-in.

6. A method as claimed in claim 1, wherein the system displays only a least time based route or a least distance based route.

7. A method of electronically ordering and seeking delivery of goods or services by an individual, which comprises:
a. providing the individual with a device or interface equipped with a system into which the individual provides a location information and a goods or service request, following which the system displays various providers in the geographical areas marked within concentric circles from the location, and also displays a delivery time of the goods or service at the location, in each concentric circle;
b. the individual making a selection of the provider from a concentric circle based on a desired delivery time placing the order, paying there for and receiving an order confirmation from the system; and
c. the individual obtaining the goods or service by delivery at the location within the desired delivery time.

8. A method as claimed in claim 7, wherein the provider is a restaurant.

9. A method as claimed in claim 7, wherein the individual selects a provider after narrowing down from the list of providers in step (a) based on the nature of goods or service he seeks.

10. A method as claimed in claim 7, wherein the device has a Global Positioning System (GPS) capability built-in.

11. A method as claimed in claim 7, wherein the innermost circle within the concentric shows the least time or least distance and the outermost circle of the concentric shows the longest time or longest distance.

12. A method of electronically ordering and picking-up goods or services by an individual using a time and distance-optimizing system, which comprises:
a. providing the individual with a device or interface equipped with a time and distance-optimizing system, into which the individual provides a location information, a request for goods or service and either a desired time or desired distance that the individual is willing to spend in obtaining the goods or service at a goods or service provider; following which the system displays various providers around the location who will satisfy the parameter of either the desired time or the desired distance in obtaining the goods or service;
b. the individual making a selection of the provider and paying for the order;
c. the individual obtaining the goods or service by reaching the provider from the location using the best route as communicated by the system in a manner that will satisfy either the parameter of the desired time or the parameter of the desired distance.

13. A method as claimed in claim 12 in which, after step (b), the individual further selects additional goods or service provider(s) based on the time or distance remaining from the parameter of the desired time or the parameter of the desired distance.

14. A method as claimed in claim 12, wherein the provider is a restaurant.

15. A method as claimed in claim 12, wherein the individual selects a provider after narrowing down from the list of providers in step (a) based on the nature of goods or service he seeks.

16. A method as claimed in claim 12, wherein the device has a Global Positioning System (GPS) capability built-in.

17. A method as claimed in claim 12, wherein the desired time or desired distance includes obtaining goods or service and reaching the location back using the best route communicated by the system.

18. A method of electronically ordering and picking-up goods or services by an individual which comprises:
a. providing the individual with a device or interface equipped with a system into which the individual provides a location information and a goods or service request, following which the system displays various goods or service providers in the geographical areas marked within concentric circles from the location with either the time or distance information within each concentric circle that will be consumed in obtaining the goods or service;
b. the individual making a selection of the provider from a concentric circle based on a desired time or a desired distance;
c. the individual placing the order, paying there for and receiving an order confirmation from the system; and
d. the individual obtaining the goods or service by reaching the goods or service provider from the location using the best route as communicated by the system in a manner that will satisfy either the parameter of the desired time or the parameter of the desired distance.

19. A method as claimed in claim 18, wherein the provider is a restaurant.

20. A method as claimed in claim 18, wherein, the individual selects a provider after narrowing down from the list of providers in step (a) based on the nature of goods or service he seeks.

21. A method as claimed in claim 18, wherein the device has a Global Positioning System (OPS) capability built-in.

22. A method as claimed in claim 18, wherein the desired time or desired distance includes obtaining goods or service and reaching the location back using the best route communicated by the system.

23. A time and distance-optimizing system for use by an individual for electronically ordering goods or services, which:
a. allows the individual provided with a device or interface equipped with the system, to provide his origin and destination information therein, following which the system displays route options including one of least time and one of least distance between the origin and destination;
b. allows the individual to further provide to the system, a request for goods or service and either an additional time or additional distance over the least time or least distance that the individual is willing to spend in obtaining the order or service at a goods or service provider and reaching the destination;
c. computes and displays the geographical area on and around the least time route or the least distance route, based on either the additional distance or additional time chosen by the individual, so that it will satisfy either the parameter of the least time+the additional time or the parameter of the least distance+the additional distance, and then provides a list of providers in the said area and then allows the individual to make a selection of the provider from the list;
d. allows the individual to place the order and pay there for; and
e. communicates to the individual the best route of reaching his provider from origin to obtain goods or service and thereafter communicates to the individual the best route to reach his destination, in a manner that will satisfy either the parameter of the least time+the additional time or the parameter of the least distance+the additional distance.

24. A system as claimed in claim 23 in which, after step (d), the system allows the individual to further select additional goods or service provider(s) based on the time or distance remaining from the parameter of the least time+the additional time or the parameter of the least distance+the additional distance.

25. A system as claimed in claim 23, wherein the list of providers as computed in step (c) will include those that allow time to reach the provider, obtain goods or service and further reach destination.

26. A system as claimed in claim 23, wherein the provider is a restaurant and the method facilitates a take-out, origin to destination enroute.

27. A system as claimed in claim 23, wherein the system allows the individual to select a provider after narrowing down from the list of providers in step (c) based on the nature of goods or service he seeks.

28. A system as claimed in claim 23, wherein the device has a Global Positioning System (GPS) capability built-in.

29. A system as claimed in claim 23, wherein the system displays route options of only least time and least distance.

30. A system for an individual for electronically ordering and seeking delivery of goods or services, which:
a. allows an individual provided with a device or interface equipped with the system, to provide a location information and a goods or service request therein, following which the system displays various providers in the geographical areas marked within concentric circles from the location, and also displays the delivery time of the goods or service at the location, in each concentric circle;
b. allows the individual to make a selection of the provider from a concentric circle based on a desired delivery time; and
c. allows the individual to place the order, pay there for, receive an order confirmation and thereafter obtain the goods or service by delivery at the location within the desired delivery time.

31. A system as claimed in claim 30, wherein the provider is a restaurant.

32. A system as claimed in claim 30, wherein the system allows the individual to select a provider after narrowing (town from the list of providers in step (a) based on the nature of goods or service he seeks.

33. A system as claimed in claim 30, wherein the device has a Global Positioning System (GPS) capability built-in.

34. A system as claimed in claim 30, wherein the innermost circle within the concentric shows the least time or least distance and the outermost circle of the concentric shows the longest time or longest distance.

35. A time and distance-optimizing system for an individual for electronically ordering and picking-up goods or services, which:
a. allows the individual provided with a device or interface equipped with the system, to provide therein a location information, a request for goods or service and either a desired time or desired distance that the individual is willing to spend in obtaining the goods or service at a goods or service provider; following which the system displays various providers around the location who will satisfy the parameter of either the desired time or the desired distance in obtaining the goods or service;
b. allows the individual to make a selection of the provider and pay for the order;
c. communicates to the individual the best route to reach the provider from the location in a manner that will satisfy either the parameter of the desired time or the parameter of the desired distance; and obtain the goods or service.

36. A system as claimed in claim 35 in which, after step (b), the system further allows the individual to select additional goods or service provider(s) based on the time or distance remaining from the parameter of the desired time or the parameter of the desired distance.

37. A system as claimed in claim 35, wherein the provider is a restaurant.

38. A system as claimed in claim 35, wherein the system allows the individual selects a provider after narrowing down from the list of providers in step (a) based on the nature of goods or service he seeks.

39. A system as claimed in claim 35, wherein the device has a Global Positioning System (GPS) capability built-in.

40. A system as claimed in claim 35, wherein the desired time or desired distance includes obtaining goods or service and reaching the location back using the best route communicated by the system.

41. A system for an individual for electronically ordering and picking-up goods or services, which:
a. allows the individual provided with a device or interface equipped with a system, to provide a location information and a goods or service request therein, following which the system displays various providers in the geographical areas marked within concentric circles from the location with either the time or distance information within each concentric circle that will be consumed in obtaining the goods or service;
b. allows the individual to make a selection of the goods or service provider from a concentric circle based on a desired time or a desired distance;
c. allows the individual to place the order, paying there for and receive an order confirmation from the system; and
d. communicates to the individual the best route to reach the provider from the location and obtain the goods or service, in a maimer that will satisfy either the parameter of the desired time or the parameter of the desired distance.

42. A system as claimed in claim 41, wherein the provider is a restaurant.

43. A system as claimed in claim 41, wherein, the system allows the individual to select a provider after narrowing down from the list of providers in step (a) based on the nature of goods or service he seeks.

44. A system as claimed in claim 41, wherein the device has a Global Positioning System (GPS) capability built-in.

45. A system as claimed in claim 41, wherein the desired time or desired distance includes obtaining goods or service and reaching the location back using the best route communicated by the system.
